(19) United States
(12) Patent Application Publication
(10) Pub. No.: US 2008/0012173 A1
(43) Pub. Date: Jan. 17, 2008

(54) Method of producing insert-molded product and insert-molding die

(75) Inventor: Kazuhiro Asao, Yokkaichi-City (JP)

Correspondence Address: CASELLA & HESPOS, 274 MADISON AVENUE, NEW YORK, NY, 10016, US

(73) Assignee: Sumitomo Wiring Systems, Ltd., Yokkaichi-City (JP)

(21) Appl. No.: 11/827,356

(22) Filed: Jul. 11, 2007

(30) Foreign Application Priority Data
Jul. 13, 2006 (JP) 2006-192836

(51) Int. Cl. B29C 45/14

(52) U.S. Cl. 264/255; 264/275; 264/279; 425/117

(57) ABSTRACT

An insert-molded product (1) has inserts (10, 20) and a resin-molding part (30) integral with the inserts (10, 20). One end (11A) of a connection terminal (11) of the insert (10) projects along a die-removal direction of a molding die (40) and fits in a setting hole (44) formed on an inner surface of a cavity of the molding die (40). One portion of a cavity surface of the molding die (40) contacts a side surface of the insert (10). A slide core (45) is formed on a contact surface (43A) of the cavity surface and moves orthogonal to the die-removal direction. The slide core (45) fits in a fit-in part (12) formed on a to-be-contacted surface (13) of each of the inserts (10, 20).

### BACKGROUND OF THE INVENTION

1. Field of the Invention

The invention relates to a method of producing an insert-molded product and an insert-molding die.

2. Description of the Related Art

Japanese Patent Application Laid-Open No. 2006-142513 discloses a method for producing an insert-molded product by positioning an insert in a molding die and forming a resin-molding part on an outer surface of the insert by insert-molding. The insert used in this method includes a metal nut and a resin holding member that is fit over the metal nut. The holding member is formed with a positioning hole. A positioning pin is provided on the lower die and is fit in the positioning hole to position the insert vertically. The molding die then is closed, and resin is injected into the resin-molding space to form the resin-molding part on the outer surface of the insert by insert-molding.

The above-described method has the positioning hole formed on a surface of the insert that remains exposed on the outer surface of the insert-molded product. Thus, there is a fear that water will penetrate into the boundary between the insert and the resin-molding part.

The invention has been made in view of the above, and an object of the invention is to place an insert in position without exposing a boundary between the insert and a resin-molding part to the outside after insert-molding.

### SUMMARY OF THE INVENTION

The invention relates to a method of producing an insert-molded product by injecting resin into a cavity of a molding die while an insert is in the cavity. The insert used in the method includes at least one connection terminal with opposite first and second ends. The insert further includes resin molded around intermediate parts of the connection terminal by insert molding, while leaving the opposite ends of the connection terminal exposed. Thus, the insert includes a unitary matrix of resin that surrounds and engages the intermediate parts of the connection terminal. The insert formed in this manner is used in a subsequent insert molding. More particularly, the first end of the connection terminal is aligned to project along a die-removal direction of the molding die that is used in the subsequent insert molding. The first end of the connection terminal then is inserted into a setting hole formed on an inner surface of the mold cavity. Additionally, one portion of a contact surface of the molding die is brought into contact with a to-be-contacted surface on a side of the insert. A slide core is movable in a direction orthogonal to the die-removal direction and relative to the contact surface of the molding die. The slide core is removably fit in a fit-in part on the to-be-contacted region of the insert that is to be contacted by the contact surface. Thus, the insert is positioned in the molding die by inserting the first end of the connection terminal into the setting hole and fitting the slide core in the fit-in part.

The method assures that the pin mark for positioning is not on the upper and lower surfaces of the insert-molded product, and the boundary between the insert and the resin-molding part is not exposed to the outside. As a result, water will not penetrate into the boundary between the insert and the resin-molding part.

The fit-in part preferably is formed concavely on the to-be-contacted surface, and the slide core preferably is fit in the concavity of the fit-in part.

The invention also relates to an insert-molding die that has an insert-molding cavity for producing an insert-molded product. The insert-molded product includes a resin-molding part that is formed integrally with an insert by injecting resin into the insert-molding cavity while the insert is accommodated in the cavity. The insert that is placed in the insert-molding cavity includes at least one connection terminal formed from a wiring material and having opposite first and second ends. The insert also includes resin formed around intermediate parts of the connection terminal by insert-molding. The insert is placed in the insert-molding cavity of the insert-molding die so that first end of the connection terminal projects along a die-removal direction of the insert molding die. The inner surface of the cavity of the insert-molding die includes a setting hole for receiving the first end of the connection terminal. A to-be-contacted surface is formed on a side of the insert includes a fit-in part. The insert-molding cavity includes a contact surface that is configured to contact the to-be-contacted surface of the insert. The contact surface of the insert-molding cavity includes a slide core that can fit in and remove from the fit-in part of the insert.

The insert-molded product preferably has a hood extending from a peripheral edge of the to-be-contacted surface along a moving direction of the slide core. The slide core preferably is a slide die having a cavity surface for molding an inner peripheral surface of the hood. The slide core preferably fits in the fit-in part when the slide die for molding the inner peripheral surface of the hood is closed. The slide core avoids a more complicated die that has a slide die with a separate slide core. Thus, the construction of the molding die is simplified.

The fit-in part of the to-be-contacted surface preferably is concave, and the slide core preferably is configured to fit in the concave fit-in part.

There is a fear that the insert will rotate on the slide core if a single slide core with a circular cross-section is used. Therefore, the slide core and the fit-in part preferably are formed at plural positions to prevent rotation of the insert.

The slide core can be fit in the fit-in part. Therefore, it is unnecessary to form a projection on the outer surface of the insert-molded product and the insert-molded product can be kept small.

### BRIEF DESCRIPTION OF THE DRAWINGS

FIG. 1 is a sectional view showing a state in which an insert member is placed in position in a molding die in a first embodiment.

FIG. 2 is a sectional view showing a state in which resin is injected to the insert member placed in position so as to form a resin-molding part by insert-molding.

FIG. 3 is a bottom view of an insert-molded product.

FIG. 4 is a sectional view of the insert-molded product.

FIG. 5 is a side view of the insert-molded product.

FIG. 6 is a front view of the insert-molded product 10.

FIG. 7 is a front view of an alternate insert-molded product.

### DETAILED DESCRIPTION OF THE PREFERRED EMBODIMENTS

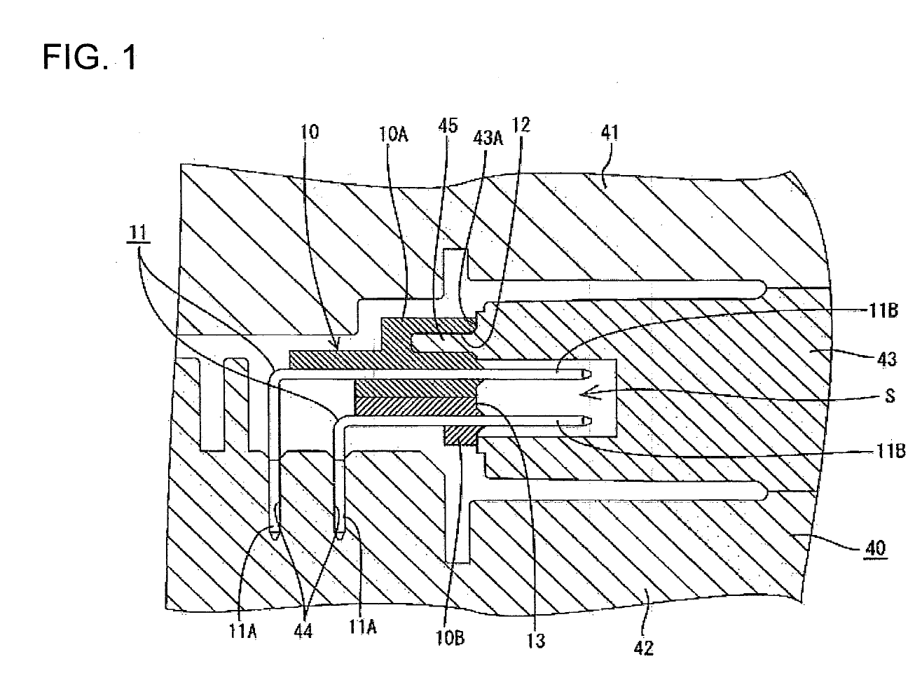

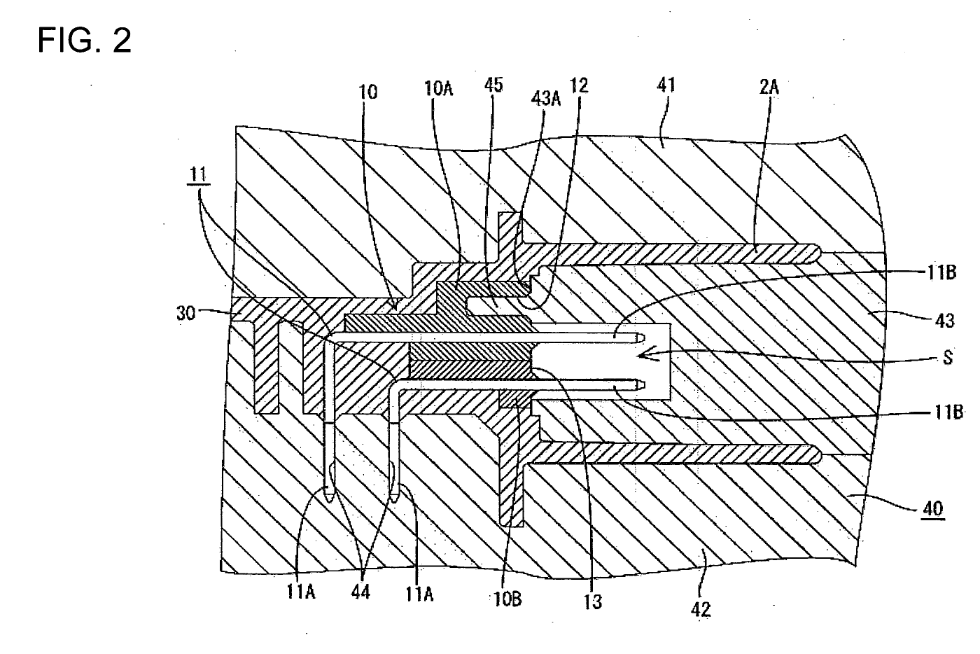

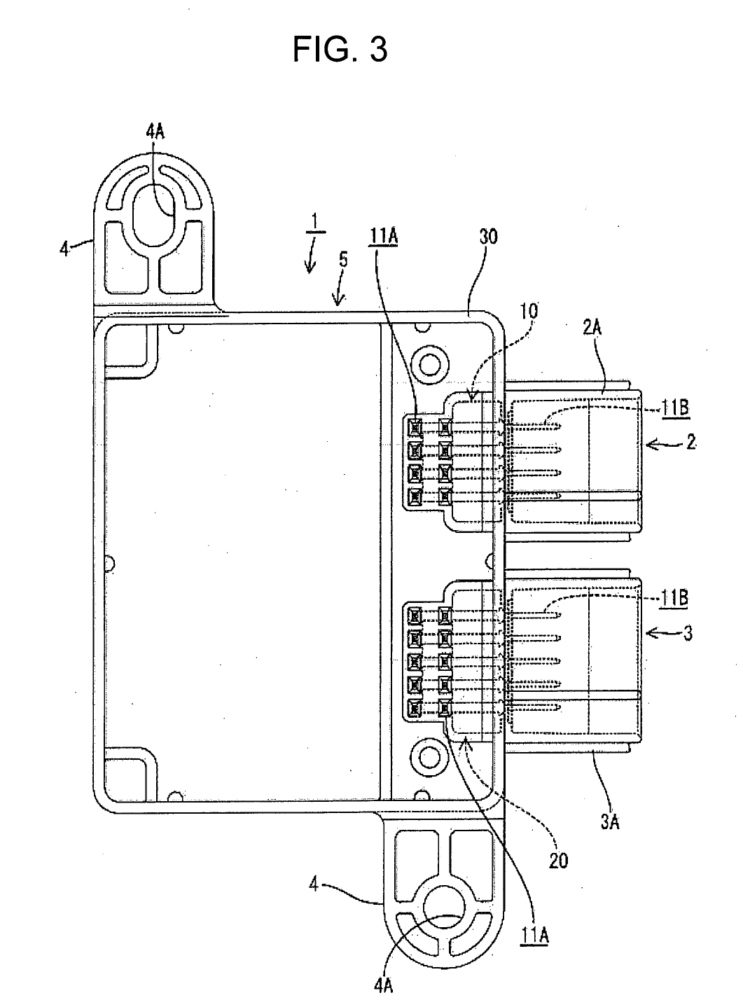

An insert molded product in accordance with the invention is described below with reference to FIGS. 1 through 7 and is identified generally by the numeral 1 in FIG. 3. The insert-molded product 1 has first and second connection parts 2 and 3 and two fixing portions 4 that project from an approximately square case 5. The connection parts 2 and 3 have many common features. Those common features are described in detail with respect to the first connection part 2, but are described again with respect to the second connection part 3. In the follow description, the longitudinal direction is considered to extend in the left-to-right direction in FIG. 1 and vertically in FIG. 3. The front is to the right in FIG. 1 and projects down in FIG. 3.

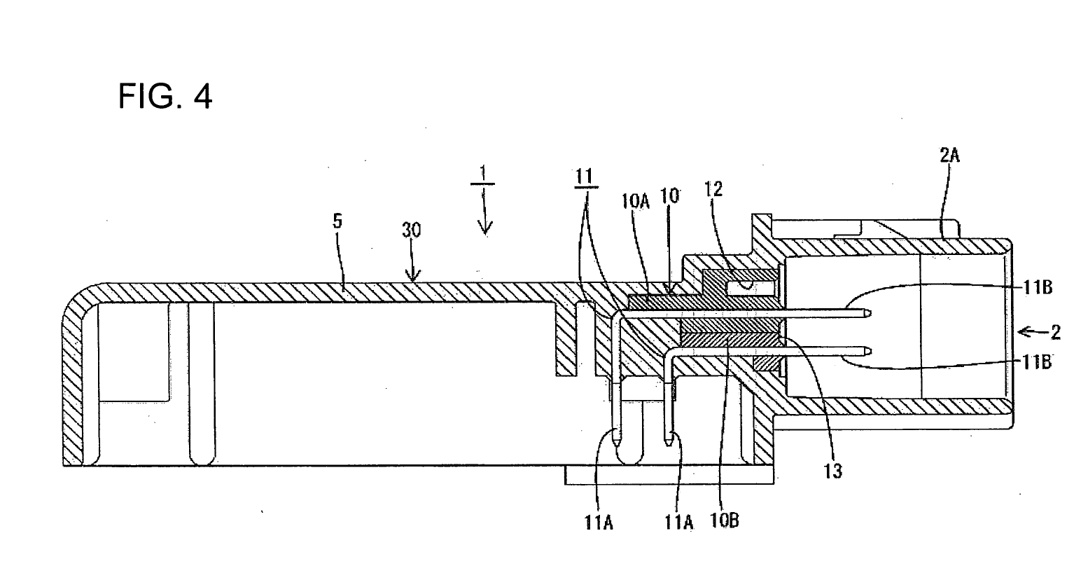

As shown in FIG. 4, the case 5 is constructed to open down and an unillustrated printed-circuit board or the like can be incorporated inside the case 5. The fixing portions 4 are provided at diagonal parts of a peripheral surface of the case 5, and an insertion hole 4A penetrates through each fixing portion 4. An unillustrated bolt is inserted into the insertion hole 4A and is screwed on a female screw tapped on a mating member to fix the insert-molded product 1. The insert-molded product 1 is formed by setting inserts 10, 20 inside a molding die 40, injecting resin in a resin-molding space between an outer surface of each of the inserts 10, 20 and an inner surface of a cavity of the molding die 40 to form a unitary resin-molding part 30 on the outer surface of the inserts 10, 20 by insert-molding. The inserts 10, 20 and adjacent portions of the resin-molded part 30 define the connection parts 2, 3 of the insert-molded product 1

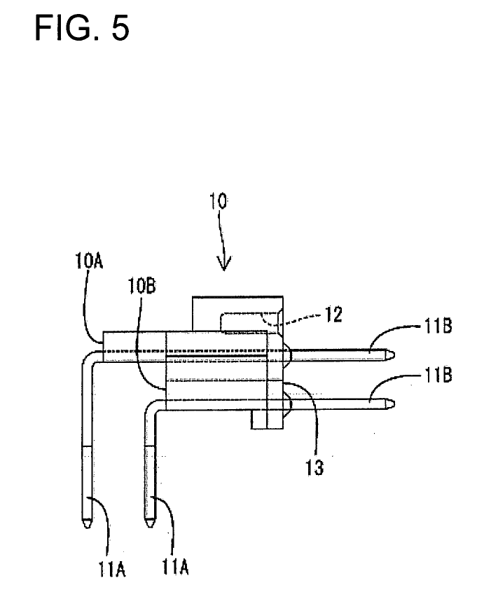

The first connection part 2 has a forwardly open hood 2 and connection terminals 11 project forward through a rear wall of the hood 2. A front surface 13 of the insert 10 is disposed on a front surface of the rear wall of hood 2 through which the connection terminals 11 extend and is exposed to the outside. To achieve this exposure, the front surface 13 of the insert 10 contacts a front-end surface 43A of a slide die 43 during insert molding as described below. Thus, the resin-molding part 30 is not molded adjacent the front surface 13 of the insert 10. As shown in FIG. 5, the insert 10 includes first and second members 10A and 10B. The first member 10A is longer than the second member 10B and is placed on an upper surface of the second member 10B. In this state, front surfaces of the first and second members 10A and 10B are flush with each other and form the front surface 13 of the insert 10.

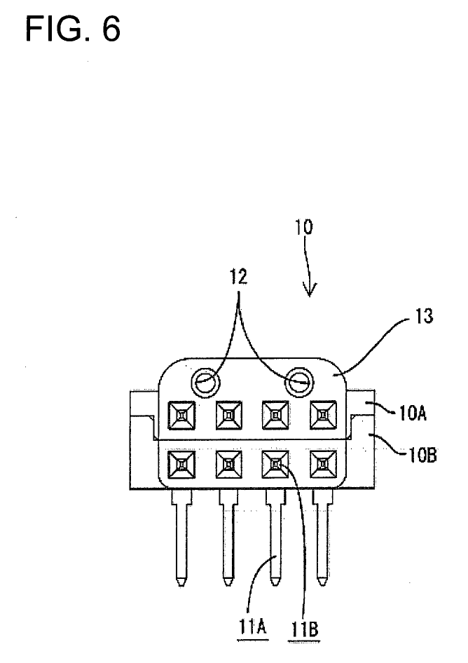

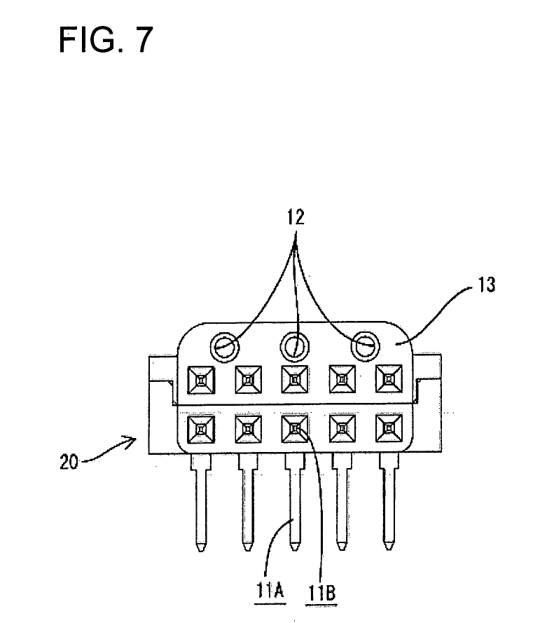

Approximately L-shaped connection terminals 11 are formed inside the first and second members 10A and 10B by insert-molding. Downwardly projecting first ends 11A of the connection terminals 11 are substantially flush with one another. The opposite second ends 11B of the connection terminals 11 projects forward and also are substantially flush with one another. Forwardly-open concave fit-in parts 12 are formed on the first member 10A above the connection terminal 11 and on a side of the first member 10A opposite the second member 10B. Each fit-in part 12 is a hole with a circular cross-section. As shown in FIG. 6, two fit-in parts 12 are formed at laterally spaced positions in the insert 10. As shown in FIG. 7, three fit-in parts 12 are formed at laterally spaced positions of the insert 20. The plural fit-in parts 12 ensure that the inserts 10, 20 will not rotate on a slide core 45.

As shown in FIG. 1, the molding die 40 has an upper die 41, a lower die 42, and a slide die 43. The upper and lower dies 41 and 42 define a vertical die-removal direction relative to one another. Each of the upper and lower dies 41, 42 has a cavity surface for molding upper and lower surfaces of the insert-molded product 1. Setting holes 44 are formed on the cavity surface of the lower die 42 for receiving the lower ends 11A of the connection terminals 11. The setting holes 44 have a configuration substantially fitting to the sectional configuration of the lower ends 11A of the connection terminals 11. Thus, the insert 10 is positioned above the cavity surface of the lower die 42 when the lower ends 11A of the connection terminals 11 are inserted into the setting hole 44. After insert molding, the lower ends 11A of the connection terminals 11 that had been inserted into the setting holes 44 project from the outer surface of the insert-molded product 1.

The slide die 43 is movable in the longitudinal direction, which is orthogonal to die-removal direction of upper and lower dies 41, 42. The slide die 43 has a cavity surface for forming an inner peripheral surface of the hood 12 of the first connection part 2. An escape space S for accommodating the second end 11B of the connection terminal 11 is formed concavely on a front-end contact surface 43A of the slide die 43. When the insert molding is performed, the front surface 13 of the insert 10 closely contacts the peripheral edge of the opening of the escape space S to prevent resin from penetrating into the escape space S.

Round rod-shaped slide cores 45 project from the front-end surface 43A of slide die 43 at positions corresponding to the positions of the fit-in part 12, when the insert molding is performed. The diameters of the slide cores 45 almost equal or are slightly smaller than that of the hole of the fit-in part 12. Thus, the slide cores 45 can be fit in the fit-in parts 12 of the insert 10. In a state where the slide cores 45 are fit in the fit-in parts 12, the insert 10 can be placed in position unmovably in the vertical and width directions orthogonal to axial direction of slide core 45.

Initially the lower ends 11A of the connection terminals 11 of the insert 10 are inserted into the setting holes 44 to place the insert 10 in position above the inner surface of the cavity of the lower die 42. In this state, the insert 10 is fixed unmovably longitudinally. In a similar manner, the insert 20 is placed in position above the inner surface of the cavity of the lower die 42.

The slide die 43 then is moved to the front surface 13 of the insert 10. As a result, the slide core 45 fits in the fit-in part 12 and the insert 10 is placed in position unmovably in the vertical and widthwise directions. The insert 20 is placed in position in a similar manner. The front surface 13 of the insert 10 closely contacts the peripheral edge of the opening of the escape space S to prevent the resin from penetrating into the escape space S.

The upper die 41 then is moved down to complete the closing of the molding die 40. In the state where the upper die 41 is closed, the resin-molding space is formed with the cavity surface of the upper die 41, that of the lower die 42, that of the slide die 43, and the outer surface of the insert member 10. The resin-molding part 30 is formed on the outer surface of the insert 10 by injecting the resin into the resin-molding space. Thus, the first connection part 2 and the second connection part 3 are formed at positions corresponding to the positions of the inserts 10, 20 respectively, and the case 5 is formed rearward from the inserts 10, 20. The upper die 41 then is opened to take out the insert-molded product 1. Consequently a pin mark for positioning use does not remain on the upper and lower surfaces of the inserts 10, 20 and there is no fear that water penetrates into the boundary between the insert 10 and the resin-molding part 30.

The above-described mold and molding method has several advantages. In particular, the lower ends 11A of the connection terminal 11 are inserted into the setting holes 44 to place the insert 10 in position above the bottom surface of the lower die 42. The slide cores 45 then are fit in the fit-in parts 12 formed on the front surface 13 of the insert 10. Thus, the insert 10 is placed in position. Therefore the pin marks for positioning use does not remain on the upper and lower surfaces of the insert-molded product 1. Additionally, the positioning construction does not cause the boundary between the insert 10 and the resin-molding part 30 to be exposed to the outside. Therefore there is no fear that water penetrates into the boundary between the insert 10 and the resin-molding part 30. That is, the positioning construction is capable of keeping the molding die airtight.

The slide cores 45 fit in the fit-in parts 12 when the slide die 43 for molding the inner peripheral surface of the hood 2A is closed. Thus, the insert 10 is placed in position. Because the slide core 43 is utilized as the slide core 45, it is unnecessary to provide the slide die 43 with the slide core 45 separately and the construction of the molding die 40 is simple.

A round rod-shaped slide core 45 and a circular hole-shaped fit-in part 12 formed at one position respectively creates a fear that the insert 10 will rotate on the slide core 45. However, slide cores 45 and fit-in parts 12 are formed at a plurality of positions to prevent rotation of the insert 10.

The slide cores 45 can be fit in the fit-in parts 12. Thus, there is no need for a projection on the outer surface of the insert-molded product 1, and the insert-molded product 1 is not enlarged unnecessarily.

The invention is not limited to the above-described embodiment described above with reference to the drawings. For example, the following embodiments are included in the technical scope of the present invention.

In the above-described embodiment, the slide cores 45 and the slide die 43 are integral with each other. However, the slide core 45 and the slide die 43 can be formed separately. Further only the slide core 45 may be formed without forming the slide die 43.

In the above-described embodiment, plural slide cores 45 are formed. But in the present invention, one slide core 45 may be formed. In this case, it is desirable that the slide core 45 and the hole of the fit-in part 12 are formed with a non-round cross-section to prevent the rotation of the insert 10.

In the above-described embodiment, the fit-in part 12 is concavely formed on the front surface 13 of the insert 10. But in the present invention, the fit-in part 12 may project from the front surface 13 of the insert 10. Further a concave portion into which the fit-in part 12 can be fit may be formed at the lead edge of the slide core 45.

What is claimed is:

1. A method of producing an insert-molded product (1), comprising:
providing at least one connection terminal (11) having first and second ends (11A, 11B) and an intermediate portion between the ends (11A, 11B);
molding resin around the intermediate portion of the connection terminal (11) by insert-molding so that the resin defines an integral matrix of the resin surrounding the intermediate portion of the connection terminal (11) while leaving the first and second ends (11A, 11B) exposed to define at least one insert (10; 20);
aligning the first end (11A) of the connection terminal (11) to project along a die-removal direction of a molding die (40);
inserting the first end (11A) of the connection terminal (11) along the die-removal direction and into a setting hole (44) formed on an inner surface of a cavity of the molding die (40);
moving a slide die (43) in a slide direction orthogonal to the die-removal direction and into contact with a to-be-contacted surface of the insert (10; 20);
closing the molding die (40) to define a resin molding space around parts of the insert (10; 20); and
injecting resin into the resin molding space of the molding die (40) to form the insert molded product (1) with a unitary resin molding part (30) surrounding and engaging at least portions of the insert (10; 20).

2. The method of claim 1, wherein the insert (10; 20) is molded to includes at least one fit-in part (12), the slide die (43) having at least one slide core (45) projecting along the slide direction, the step of moving the slide die (43) along the slide direction including moving the slide core (45) into the fit-in part (12).

3. The method of claim 2, wherein the at least one fit-in part (12) comprises plural fit-in parts (12) and the at least one slide core (45) comprises plural slide cores (45) projecting from the slide die (43), the method including moving the plural slide cores (45) into the respective fit-in parts (12).

4. The method of claim 3, wherein the fit-in parts (12) are concavities with substantially round cross-sections, and the slide cores (45) are projections with substantially round cross-sections, the method comprising moving the slide cores (45) substantially normal to the round cross-sections thereof.

5. The method of claim 2, wherein the step of injecting resin into the resin molding space comprises forming a hood (12) projecting forward from the fit-in part (12) of the insert (10; 20) along the slide direction.

6. The method of claim 1, wherein the step of inserting the first end (11A) of the connection terminal (11) along the die-removal direction and into a setting hole (44) comprises positioning the resin of the insert (10; 20) in spaced relation to at least parts of the molding die (40) along the die removal direction.

7. An insert-molding die assembly, comprising:
a first die (41);
a second die (42) substantially opposed to the first die (41), at least one of the first and second dies (41, 42) being movable relative to the other along a die removal direction, the second die (42) having at least one setting hole (44) extending into a surface of the second die (42) facing the first die (41) so that the setting hole (44) extends along the die removal direction; and
a slide die (43) movable towards and away from the first and second dies (41, 42) along directions substantially normal to the die removal direction.

8. The insert-molding die assembly of claim 7, wherein the at least one setting hole (44) comprises plural parallel setting holes (44).

9. The insert-molding die assembly of claim 8, wherein the first and second dies (41, 42) and the slide die (43) are configured to define an insert-molding cavity therebetween.

10. The insert-molding die assembly of claim 7, further comprising at least one insert (10; 20) in the cavity, the insert (10; 20) having at least one connection terminal (11) having first and second ends (11A, 11B) and an intermediate portion between the ends (11A, 11B), resin surrounding the intermediate portion of the connection terminal (11), the first end (11A) of the connection terminal (11) being supported in the setting hole (44), the second end (11B) of the connection terminal (11) being surrounded by a portion of the slide die (43).

11. The insert-molding die assembly of claim 10, wherein the resin of the insert (10; 20) is formed with at least one fit-in part (12), the slide die (43) being formed with at least one slide core (45) engaged in the fit-in part (12).

12. The insert-molding die assembly of claim 11, wherein the at least one fit-in part (12) comprises plural fit-in parts (12), and the at least one slide core (45) comprises plural side cores (45).

13. The insert-molding die assembly of claim 12, wherein the slide cores (45) are unitary with the slide die (43).

14. The insert-molding die assembly of claim 13, wherein the fit-in parts (12) and the slide cores (45) each have substantially circular cross-sections.
